(19) United States
(12) Patent Application Publication
(10) Pub. No.: US 2007/0278910 A1
(43) Pub. Date: Dec. 6, 2007

(54) Transparent locker door

(76) Inventors: Robert D. Cash, Ponca City, OK (US); Mechell C. Cash, Ponca City, OK (US)

Correspondence Address: SUNG I. OH, PROFESSIONAL LAW CORPORATION, 710 QUAIL VALLEY LANE, WEST COVINA, CA, 91791, US

(21) Appl. No.: 11/444,212

(22) Filed: May 30, 2006

(51) Int. Cl. E06B 3/50

(52) U.S. Cl. 312/109

(57) ABSTRACT

A door through which an authorized person can see into a locked locker. The door can close a locker located in a school, a bus station, an airport, or the like, and the authorized person can be a security guard.

### TECHNICAL FIELD OF THE INVENTION

The present invention relates to the general art of storage units, and to the particular field of storage lockers.

### BACKGROUND OF THE INVENTION

In the United States, storage lockers of the prior art can be found in most any school where they are provided for storage of books, clothing, and the like personal effects of attending students. Lockers can also be found in bus stations, airports, and in dressing rooms of most every professional sports organization. Actual use of a locker is limited only by one's imagination.

One problem with lockers of the prior art is the predominant use of steel. Conventional lockers are constructed of stamped steel that is painted and then assembled by use of numerous fasteners such as screws, rivets, nuts and bolts. The end product is a rectangular box with right angled edges leaving a fixture having little or no aesthetic appeal. Further, the steel locker is affected by humidity, has sharp edges, is noisy in operation, easily vandalized, and can be used in only certain environments.

For example, placement of a steel locker in a high humidity room, such as a gymnasium dressing room, will quickly uncover flaws in the coating of the steel leading to unattractive rust. Even if the locker panel is properly coated, fasteners used for assembly are notorious for scaring the locker finish propagating the locker demise.

To save weight, steel locker construction demands that the panels are made from thin sheet metal. Thin sheet metal produces sharp edges that are dangerous to handle during shipping and assembly. Thin sheet metal is noisy in operation as the metal is susceptible to vibration and the hollow structure can create an echo chamber. In schools where lockers typically line the hallways, simultaneous opening and closing of multiple locker doors can create an unbearable noise level leading to class disruption. Further, thin steel metal panels are also prone to vandalism and once a door is kicked or punched with sufficient strength to dent the sheet metal, the locker can be rendered dysfunctional.

Furthermore, use of a steel locker in a corrosive environment is an expensive proposition due to the need for specialty coatings to prevent corrosion. Simply substituting plastic as the preferred material of construction will fail if prior art teachings are replicated. In addition, plastic fasteners such as screws, nuts, or rivets cannot duplicate the strength of metal fasteners and use of such presents a locker of questionable shear strength.

In recent years, the use of public lockers has become a tool for terrorists. A terrorist can store a bomb in a public locker, set a timer and walk away. The bomb may be set to explode at a high traffic time thereby doing the maximum damage. Therefore, the use of steel has found a further disadvantage: steel is opaque and thus police or other such authorities cannot inspect the contents of steel lockers. Accordingly, such opaque lockers can be used by those intent on avoiding the law as convenient hiding places.

Still further, it has been known that smugglers use public lockers as drop off locations. Illegal items, such as drugs or the like, are left in a locker and the key is sent to another person for retrieval. Therefore, there is a need for a means for the authorities to monitor such lockers to inspect the contents of such lockers.

However, there is a privacy issue associated with such inspection. A locker should be available to law-abiding people for storage without the danger of public display of the items stored in the locker. Such public display could invite theft and thus is not desirable. Therefore, there is a need for a locker that can be used to store items in a private manner, but which can be inspected by authorities as required to prevent illegal activities.

The inventor is aware of showcases which allow display of goods or objects, while maintaining such a security class that they can be used as a cabinet approved for storing firearms at home, at arms dealers' or in museums, the inventor is not aware of any cabinet or locker that can be used in a manner which maintains the goods stored therein in private, yet will permit inspection thereof when necessary. However, these showcases do not satisfy the requirement of privacy.

The inventor is also aware of freezer and refrigerator cabinets such as used in grocery stores which have see-through doors. Again, while satisfying the needs associated therewith, such doors and cabinets do not satisfy the privacy requirement discussed above.

### SUMMARY OF THE INVENTION

The above-discussed disadvantages of the prior art are overcome by a door through which an authorized person can see into a locked locker. Using the door embodying the present invention will permit an authorized person, such as a security guard or the like, to view the contents of a locked locker while still preserving the privacy associated with such locked lockers. In this manner, illegal use of the locker is not likely to occur while legal and authorized use can still be carried out. One form of the door includes a clear window, while a second form of the door includes a louvered window that is operated by a key-controlled mechanism to which the authorized person has a key. Other forms of the door simply include transparent doors.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURE

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a front elevational view of several doors embodying the present invention.

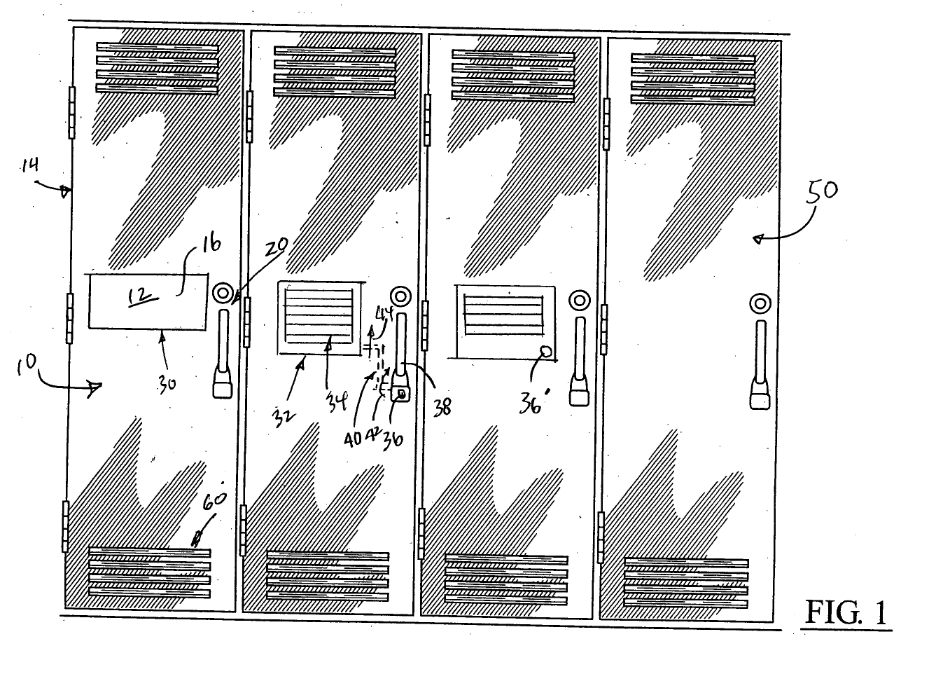

### DETAILED DESCRIPTION OF THE INVENTION

Referring to the figure, it can be understood that the present invention is embodied in a door 10 that can cover a locker or the like. Door 10 comprises transparent section 12 through which the contents of an enclosure 14 covered by the door can be viewed. A cover 16 which is mounted on the door over the transparent section prevents viewing of the contents of the enclosure when the cover is in place. The cover is movable between a contents-viewing position and a contents-covering position.

The door includes a locking element 20 which is operated by the person who is authorized to enter the locker, such as the owner or renter of the locker. The locking element can include a combination lock, a shackle lock or a key lock as is generally associated with lockers. Cover 16 is adapted to be operated by an authorized person such as a security guard or the like.

Door 10 can include a section 30 that is simply transparent, or a section 32 that includes louvers 34 that are movable between an open position and a closed position by a mechanism that includes a lock 36 on handle 38 of the locker and suitable levers and arms 40 connecting the lock to the louvers to move the louvers when the lock on the handle is turned, or when the handle is turned. Thus, when lock 36 is turned in direction 42, a portion of the levers and arms moves in direction 44 to move louvers 34 from a closed condition to an open condition. Once the authorized person has viewed the contents of the locker, he or she moves lock 36 in the opposite direction to close the louvers and restore privacy to the locker. Lock 36 can be located immediately adjacent to the louvers as indicated for lock 36′ with suitable arms and levers connecting the lock to the louvers to move the louvers as just discussed. In this manner, someone other than the owner or renter of the locker can view the contents of the locker while maintaining the privacy associated with a locked enclosure such as a locker.

Yet another form of the invention simply has a door 50 that is clear or transparent. While this form obviates privacy, in some instances it is acceptable. The doors can include vents 60 through which dogs can sniff the contents of the locker whereby drugs, explosives or the like can be detected using trained dogs.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A door comprising:
A) transparent section through which the contents of an enclosure covered by the door can be viewed;
B) a cover for the transparent section that prevents viewing of the contents of the enclosure when the cover is in place, the cover being movable between a contents-viewing position and a contents-covering position, the cover being adapted to be operated by an authorized person; and
C) a lock on the door which is adapted to be operated by someone other than the authorized person.

2. The door defined in claim 1 wherein the enclosure is a locker.

3. The door defined in claim 1 further including a vent in the door.
